(19) United States
(12) Patent Application Publication
(10) Pub. No.: US 2016/0226330 A1
(43) Pub. Date: Aug. 4, 2016

(54) ELECTRIC MOTOR

(71) Applicant: JOHNSON ELECTRIC S.A., MURTEN (CH)

(72) Inventors: YUE LI, HONG KONG (CN); YONG WANG, SHEN ZHEN (CN); YONG LI, SHEN ZHEN (CN); WAI FAT PANG, SHEN ZHEN (CN); YA MING ZHANG, SHEN ZHEN (CN); YAN FEI LIAO, SHEN ZHEN (CN); YING SONG YE, SHEN ZHEN (CN); MAO XIONG JIANG, SHEN ZHEN (CN); JIAN ZHAO, SHEN ZHEN (CN)

(21) Appl. No.: 15/011,024

(22) Filed: Jan. 29, 2016

(30) Foreign Application Priority Data
Jan. 30, 2015 (CN) 201510054879.2
Nov. 3, 2015 (CN) 201510738743.3

(51) Int. Cl. H02K 5/00; H02K 3/34; H02K 1/14; H02K 3/28; H02K 5/18; H02K 11/30

(52) U.S. Cl. CPC H02K 5/00; H02K 5/18; H02K 11/30; H02K 1/146; H02K 3/28; H02K 3/345

(57) ABSTRACT

An electric motor has a support seat, a stator and a rotor. The rotor is rotatably mounted on the support seat. The stator comprises a magnetic core, a winding frame wrapped over the core, and windings wound around the winding frame. The core includes a ring-shaped yoke and a plurality of teeth extending outwardly from the yoke. The winding frame comprises an insulating part wrapped around the core and a connecting part within the insulating part to fixedly connect to the support seat. The core is fixed to the support seat by the winding frame, which saves material and reduces the weight of the stator and the motor.

### CROSS REFERENCE TO RELATED APPLICATIONS

This non-provisional patent application claims priority under 35 U.S.C. §119(a) from Patent Application No. 201510054879.2. filed in The People's Republic of China on Jan. 30, 2015, and from Patent Application No. 201510738743.3 filed in The People's Republic of China on Nov. 3, 2015, the entire contents of both are hereby incorporated by reference.

### FIELD OF THE INVENTION

This invention relates to an electric motor and in particular, to a motor having a wound. stator core.

### BACKGROUND OF THE INVENTION

Electric motors are a common source of mechanical power, being used in a wide variety of applications and devices, such as electric fans, washing machines, water pumps etc. Generally, a motor is composed of two parts, namely a rotor and a stator. A one type of motor, the stator is composed of a magnetic core with windings wound around the magnetic core. The rotor may have a permanent magnet. When energized, the windings of the stator generate a magnetic field which interacts with a magnetic field of the rotor to rotate the rotor and in turn drive a load.

The magnetic core of a known wound stator is generally formed by stacking a large number of silicon steel sheets or laminations. Each silicon steel sheet is formed by directly punching a thin sheet material. Each silicon steel sheet comprises an annular yoke, and teeth radiating from the yoke part. For a stator used in an outer rotor motor, the teeth radiate outwardly from the yoke. An annular supporting part is formed at a central area of the yoke. The supporting part is used to fixedly connect the stator to other components. The windings are wound around the teeth. Although the manufacturing procedure of the stator core of the existing stator is simple, the punching process use to form the stator laminations generates a large amount of waste material, resulting in a high cost.

### SUMMARY OF THE INVENTION

Hence there is a desire for a motor with a stator having better rate of material utilization.

Accordingly, in one aspect thereof, the present invention provides a motor comprising: a support seat, a stator structure and a rotor, wherein the rotor is rotatably mounted on the support seat, and the stator structure comprises: a core, a winding frame covering the core, and windings wound around the winding frame, the core includes a ring-shaped yoke and a plurality of teeth extending outwardly from the yoke, the winding frame comprises an insulating part covering the core and a connecting part within the insulating part to fixedly connect to the support seat.

Preferably, each tooth includes a winding portion connected with the yoke and a tip formed at a distal end of the winding portion, the windings are wound around the winding portions, a notch is formed in a connection area between the tip and the winding portion, the tip is partially tilted outwardly before the winding is completed and is pressed to bend inwardly to contact the winding portion after the winding is completed.

Preferably, the core is formed by bending material strips, the yoke of the core has through holes, and fastening members are inserted into the through holes to fix the material strips together.

Preferably, the core is formed by bending material strips, and tips of the core are welded to fixed the strips together.

Preferably, the support seat is formed from a thermally conductive material.

Preferably, cooling fins are provided on a side of the support seat facing the stator structure.

Preferably, one side of the support seat remote from the stator structure forms a receiving cavity, and a circuit board is received in the receiving cavity.

Preferably, the connecting part comprises a ring-shaped base plate extending integrally and radially inwardly from the insulating part, a hollow cylinder extending integrally and axially from an inner edge of the base plate, and a plurality of ribs connected between an outer wall surface of the hollow cylinder and an inner wall surface of the insulating part.

Preferably, the base plate of the winding frame has through holes, the support seat is provided with fixing posts corresponding to the through holes, and fixing members pass through the through holes and are fastened in the fixing posts.

Preferably, the winding frame is an over-molded integrated structure, the fixing members are integrally fixed at the through holes of the winding frame during the course of forming the winding frame, and distal ends of the fixing members pass through the support seat to connect the stator structure with the support seat.

Preferably, the support seat is provided with a positioning post, a step is formed at a top end of the positioning post, the base plate has a positioning hole corresponding to the positioning post, the top end of the positioning post is inserted into the positioning hole, and the stator structure is disposed on the step of the positioning post.

Preferably, one of an inner wall surface of the hollow cylinder of the winding frame and an outer wall surface of the sleeve of the support seat forms a protrusion, and the other forms a recess for engaging with the protrusion to circumferentially position the stator structure.

Preferably, the insulating part is ring-shaped, the connecting part comprises a plurality of connecting lugs extending inwardly from the ring-shaped insulating part, each connecting lug forms a through hole, the support seat forms a plurality of fixing holes corresponding to the through holes of the winding frame, and fixing members pass through the through holes and are fastened in the fixing holes, respectively, to fix the stator to the support seat.

Preferably, the core has connecting arms extending inwardly from the ring-shaped yoke, the connecting part of the winding frame includes connecting lugs extending inwardly from the insulating part, the connecting lugs and the connecting arms correspond respectively and form coaxial through holes, the support seat forms a plurality of fixing holes, and fixing members pass through the through holes and are fastened in the fixing holes of the support seat, respectively.

In comparison with the conventional magnetic core, the winding frame of the present invention integrally forms the connecting part within the core to fixedly connect with the support seat, which saves material and reduces the weight of the stator structure and the motor.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below,

FIG. 1 illustrates a stator structure of a motor according to one embodiment of the present invention.

FIG. 2 is a plan view of FIG. 1.

FIG. 3 is an exploded view of FIG. 1.

FIG. 4 illustrates a winding frame of the stator, viewed from another aspect.

FIG. 5 is a perspective, sectional view of the motor according to a preferred embodiment.

FIG. 6 through FIG. 9 illustrate a motor according to another embodiment of the present invention.

FIG. 10 and FIG. 11 illustrate a motor according to further embodiment of the present invention, in which the rotor is removed.

### DETAILED DESCRIPTION OF THE PREFERRED EMBODIMENTS

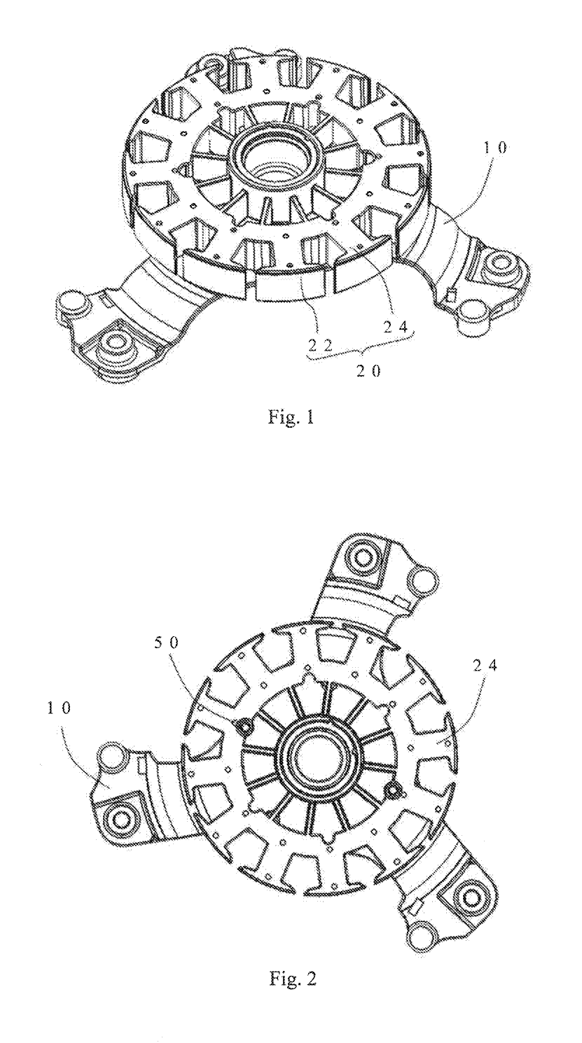

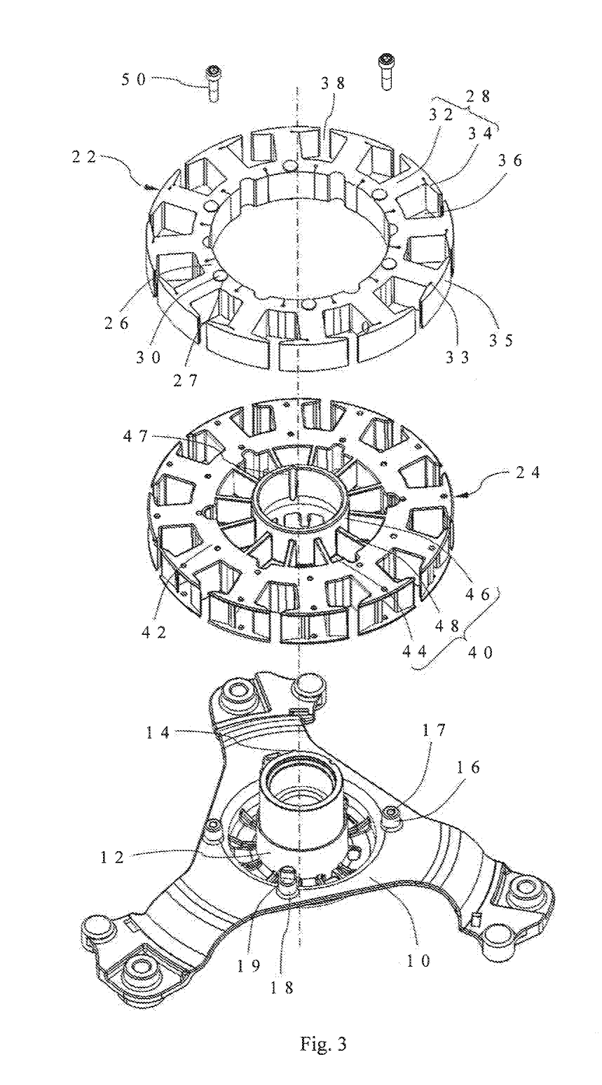

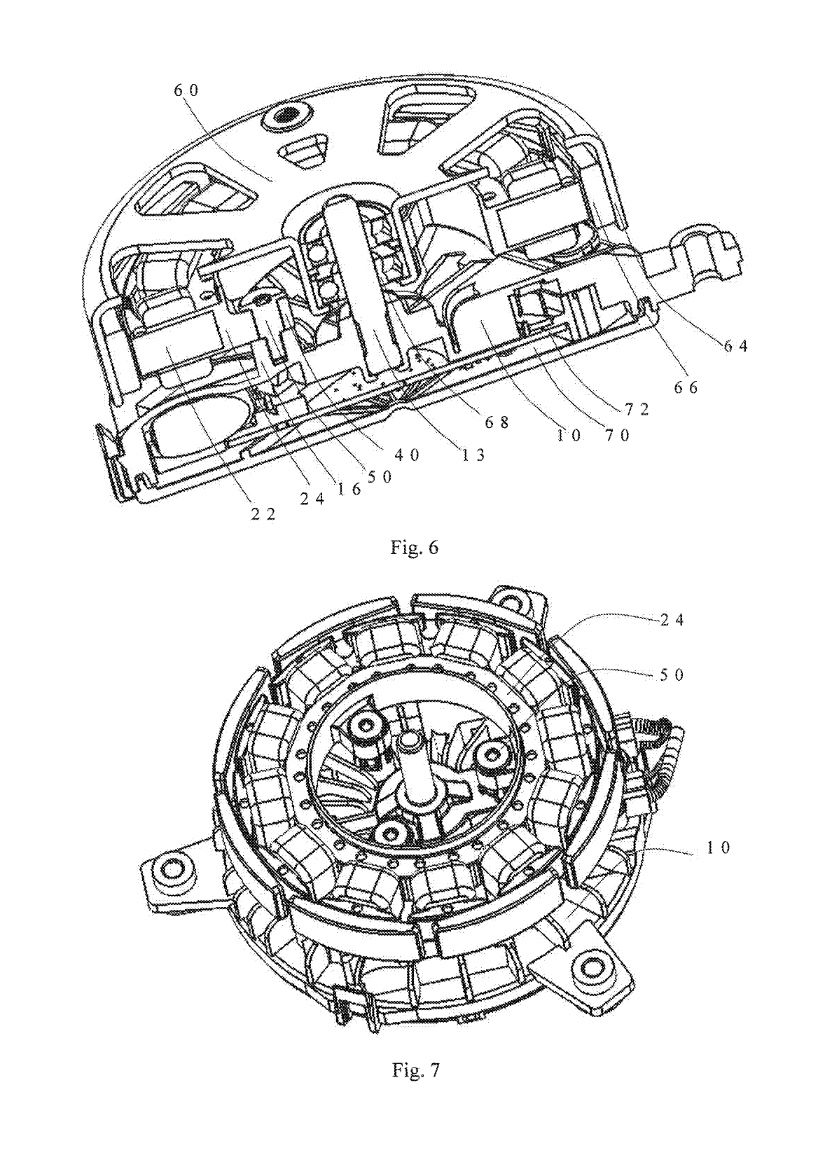

Referring to FIG. 1 through FIG. 5, a motor according to one embodiment of the present invention includes a support seat 10, a stator having a stator structure 20 attached to the support seat 10, and a rotor 60 (FIG. 5) surrounding the stator structure 20.

A center of the support seat 10 protrudes axially upwardly to form a hollow sleeve 12, and the hollow sleeve 12 is used to support a bearing or the like for supporting rotation of the rotor. An outer wall surface of a top of the sleeve 12 protrudes outwardly to form a protrusion 14, for engaging with and positioning the stator structure 20 circumferentially. The protrusion 14 is preferably cylindrical. The support seat 10 is further provided with fixing posts 16 and positioning posts 18. In this embodiment, there are two fixing posts 16 and two positioning posts 18, which surround the sleeve 12 and are alternately arranged in a circumferential direction of the sleeve 12. Each fixing post 16 is formed with a fixing hole 17 therein. The fixing hole 17 may be a round hole or a screw hole for fixed connection with the stator structure 20. A top end of each positioning post 18 is formed with a step 19 for pre-positioning the stator structure 20 in the axial direction. Preferably, the positioning post 18 is slightly higher than the fixing post 16, and the step 19 and a top surface of the fixing post 16 are located on substantially the same level.

The stator structure 20 comprises a core 22 made of a soft magnetic material, an insulating winding frame 24 wrapped over the core 22, and windings 25 wound around the core 22.

In this embodiment, the core 22 is of an integrated structure formed by spirally stacking and winding a strip material (i.e. formed by continuously spirally winding the strip material), including an annular yoke 26 and a plurality of teeth 28 that extend radially outwardly from an outer edge of the yoke 26 The yoke 26 is of a hollow cylindrical structure formed by the spiral winding of the strip material. The teeth .8 are uniformly (non-uniformly in some embodiments) disposed at intervals in a circumferential direction of the yoke 26. Compared with the traditional circular punching sheet structure, the spirally stacked and wound core 22 generates significantly less waste material, thereby improving the utilization rate of raw materials. In some embodiments, the strip materials can also be bent to form circular sheets, and the circular sheets are stacked in the axial direction of the motor to form the core 22, which likewise generates substantially less waste material. In this embodiment, a plurality of through holes 27 is formed in the yoke 26. The through holes 27 may be formed by stacking small holes in the strip materials, which are arranged uniformly (non-uniformly in some embodiments) in the circumferential direction of the yoke 26. Each through hole 27 penetrates axially through the yoke 26, and a fastening member, such as a rivet 30, passes through the through hole 27 to shape the core 22. In some embodiments, the core 22 can be shaped in other manners, such as, for example, by fixedly connecting tips 34 of the stacked teeth 14 by welding.

Each tooth 28 includes a winding portion 32 connected with the yoke 26 and a tip 34 formed at a distal end of the winding portion 32. The tip 34 extends in the circumferential direction of the motor. A winding slot 36 is formed between adjacent winding portions 32, a slot opening 38 is formed between adjacent tips 34, and the windings are wound around the winding portions 32 and disposed in the winding slots 36. Preferably, a notch 33 is formed in a connection area of the tip 34 and the winding portion 32. Before formation, the tip 34 is partially tilted outwardly, and the slot opening 38 between the adjacent tips 34 has a large size for facilitating winding. After winding is completed, the tilted part of the tip 34 is pressed to generate plastic deformation to bend inwardly, such that a root of the tip 34 is in tight contact with the winding portion 32, and a small slot opening is formed between the adjacent tips 34 to reducing cogging torque of the motor. In this embodiment, the notch 33 is only formed in a connection area of the tip 34 and in a single side of the winding portion 32. Of course, in other embodiments, the notch 33 can be formed in the connection area of the tip 34 and each side of the winding portion 32.

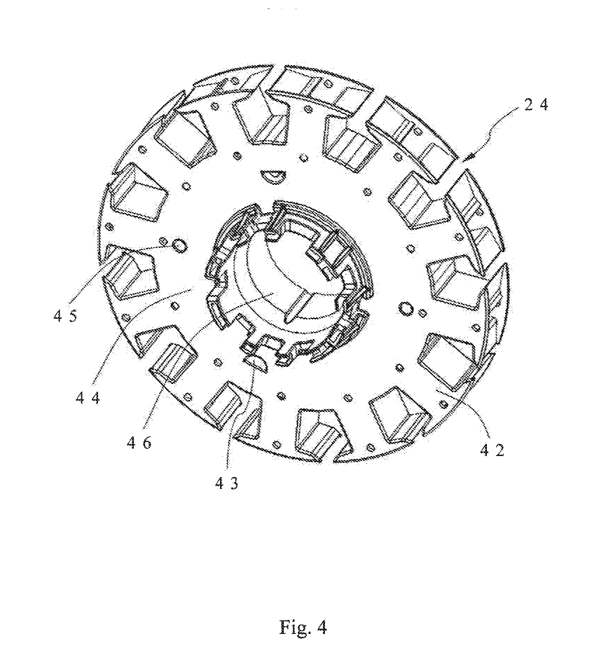

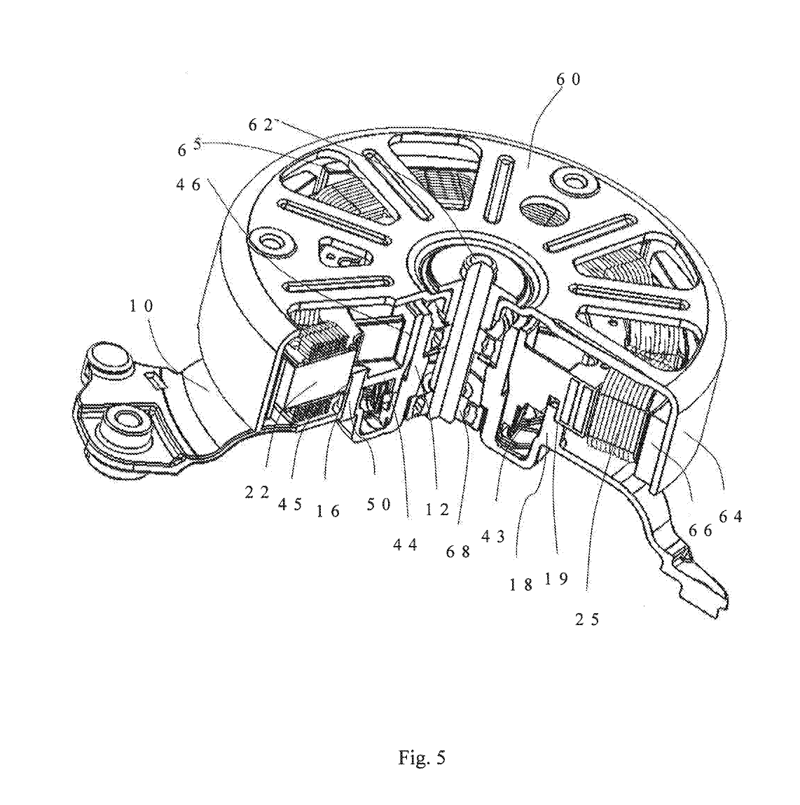

Referring to FIG. 3 and FIG. 4, the winding frame 24 is an integrated structure molded directly over the core 22 from an insulation material, such as plastic or the like. The winding frame 24 comprises a connecting part 40 for assembly, and an insulating part 42 surrounding the connecting part 40. The insulating part 42 and the core 22 are matched in profile. As shown in FIG. 5, preferably, the insulating part 42 covers all outer surfaces of the core 22, except for outer circumferential surfaces 3.5 of the tips 34, thereby ensuring insulation between the windings and the core 22 when the windings are subsequently wound around the core 22, and hence avoiding short circuit of the windings. The connecting part 40 is used to fixedly connect with the support seat 10 and includes a base plate 44 integrally extending inward from an inner edge of a bottom end of the insulating part 42, a hollow cylinder 46 formed on the base plate 44, and a plurality of ribs 48 extending between the hollow cylinder 46 and the insulating part 42.

The base plate 44 is circular ring shaped. As shown in FIG. 4, the base plate 44 forms through holes 45 and positioning holes 43 corresponding to the fixing posts 16 and positioning posts 18 of the support seat 10, respectively. In this embodiment, the through holes 45 and positioning holes 43 are all located towards an outer edge of the base plate 44, i.e. a connection area between the base plate 44 and the insulating part 42 and aligned with the inner edge of the stator core 22. The through holes 45 are round-shaped and have a diameter approximately the same as that of the fixing holes 17 of the fixing posts 17. The positioning holes 43 are half-round shaped and have a diameter approximately the same as the positioning posts 18. The hollow cylinder 46 extends axially from an inner edge of the base plate 44, which has an inner diameter that may be slightly greater than an outer diameter the sleeve 12 of the support seat 10. As shown in FIG. 3, an inner wall surface of a top end of the hollow cylinder 46 forms a. recess 47 for engaging with the protrusion 14 of the sleeve 12. It is to be understood that the protrusion 14 may also be formed on the inner wall surface of the hollow cylinder 46, and the recess 47 may be formed in the outer wall surface of the sleeve 12, or both. The ribs 48 are integrally connected between an outer wall surface of the hollow cylinder 46 and an inner wall surface of the insulating part 42, and are arranged uniformly in the circumferential direction. Bottom edges of the ribs 48 are integrally connected with the base plate 44.

As shown in FIG. 5, on assembly of the stator structure 20 to the support seat 10, the stator structure 20 and the support seat 10 are circumferentially positioned relative to each other by aligning the recess 47 of the winding frame 24 and the protrusion 14 of the support seat 10. The sleeve 12 is then inserted into the stator structure 20 in the axial direction. The top ends of the positioning posts 18 are inserted into the positioning holes 43, the through holes 45 are aligned with the fixing posts 16, and a bottom surface of the winding frame 24 is disposed on the steps 19 of the positioning posts 18 and positioning surfaces of the fixing posts 16, such that the stator structure 20 is axially positioned. Finally, fixing members 50 pass through the through holes 45 of the base plate 44 and are then fastened in the fixing holes 17 of the fixing posts 16 of the support seat 10, such that the stator structure 20 is fixedly connected to the support seat 10.

The fixing members 50 may be screws, rivets or the like. When the fixing members 50 are rivets, the fixing members 50 may be integrally fixed on the winding frame 24 during the course of forming the winding frame 24, and the fixing holes 17 are round holes passing through the fixing posts 16. In assembly, the distal ends of the fixing members 50 pass through the fixing posts 16 and are then deformed to fixedly connect the stator structure 20 with the support seat 10. When the fixing members 50 are screws, a metal piece such as a metal sleeve may be disposed in each through hole 45 when forming the winding frame 24, which prevents the winding frame 24 from being damaged during assembly.

Referring to FIG. 5, the rotor 60 includes a shaft 62, a housing 64 fixed to the rotary shaft 62, a permanent magnet 66 mounted to an inner surface of a sidewall of the housing 64. The permanent magnet 66 is opposed to the outer surfaces of the teeth 28 of the core 22, with an air gap formed there between. The permanent magnet may be a single piece magnet or composed of multiple magnet segments or pieces. The rotary shaft 62 is mounted in the sleeve 12 of the support sleeve 10 through a bearing 68. Ventilation openings 65 are formed in an end wall of the housing 64 to allow air to flow through the interior of the motor.

It is to be understood that the support seat 10 may be formed from a thermally conductive material such as aluminum. As such, the support seat 10 can also provide the heat dissipating function. After the stator structure is mounted to the sleeve 12, a free end of the sleeve 12 extends outward beyond a free end of the hollow cylinder 46. The free end of the sleeve 12 is then sealed by a tool having an arc-shaped machining surface, such that the free end of the sleeve 12 generates an outward plastic deformation thus forming a rivet connection with the stator structure. That is, an outer surface of the free end of the sleeve 12 is deformed to press against an edge of the hollow cylinder 46 of the stator structure to prevent the hollow cylinder 46 from becoming disengaged from the free end of the sleeve 12. As such, the fixing members 50 can be omitted.

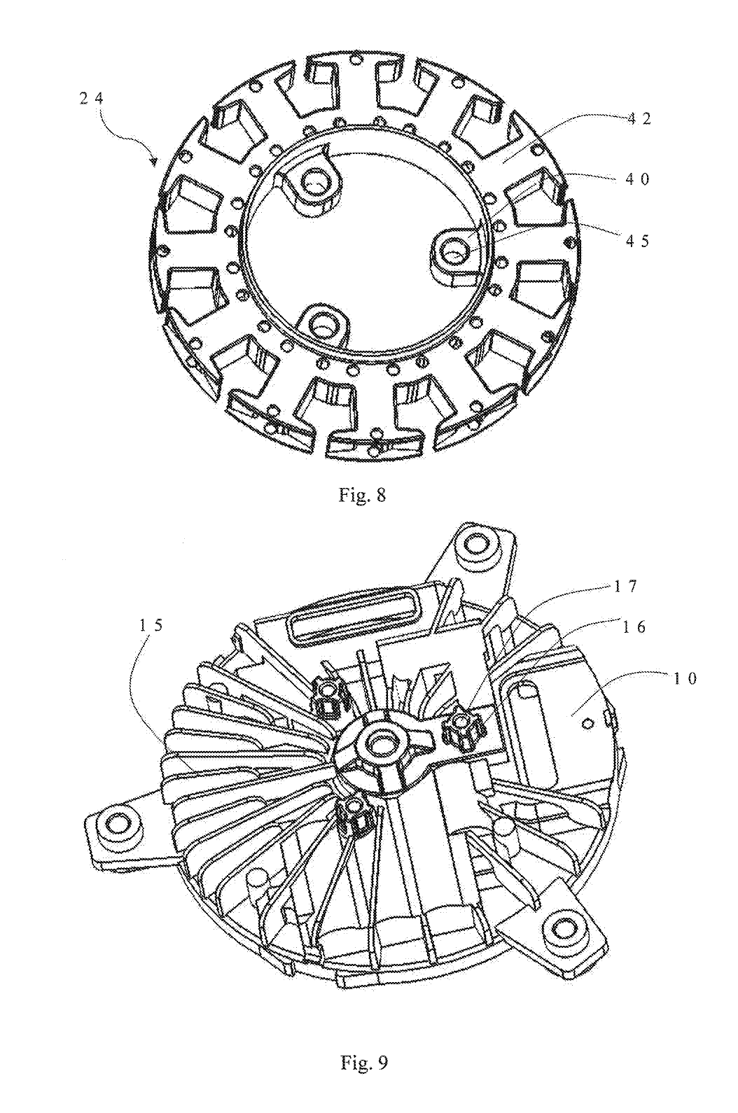

FIG. 6 through FIG. 9 illustrates a motor according to another embodiment of the present invention. In this embodiment, a plurality of cooling fins 15 is disposed on an outer surface of the support seat 10. Preferably, the cooling fins 15 are substantially in a radiating distribution, which facilitates dissipating the heat from the center to the surrounding space. One side of the support seat 10 remote from the stator is concave to form a receiving chamber 70. The motor further includes a circuit board 72 that is received in the receiving chamber 70. The winding frame 24 is an integrated structure molded directly over the stator core 22 from an insulation material, such as plastic or the like. The winding frame 24 comprises a connecting part 40 for assembly, and an insulating part 42. The insulating part 42 and the core 22 are matched in profile. Preferably, the insulating part 42 is ring-shaped, and the connecting part 40 includes a plurality of connecting lugs extending inward from the insulating part 42. Each connecting lug has a through hole 45. The support seat 10 is provided with a plurality of fixing posts 16 each defining a fixing hole 17 such as a screw hole therein. A fixing member 50 such as a screw passes through the through hole 45 of the connecting part 40 of the winding frame 24 and is then fastened in the fixing hole 17 of the support seat 10, so as to fix the stator structure to the support seat 10. In this embodiment, a motor shaft 13 is fixed to the support seat 10, and the rotor 60 is rotatably mounted to the shaft 13 via bearings 68. In this embodiment, the connecting part 40 of the winding frame 24 is implemented as the connecting lugs at the inner side of the insulating part 42. A length of the connecting lugs may be adjusted according to needs. For example, when the number of stator slats of the motor increases from twelve slots to eighteen slots, the inner diameter of the yoke 26 of the magnetic core 22 and the insulating part 42 of the winding frame 24 usually increases. In this case, by enlarging the size of the connecting part 40, the connecting part can still match with the original support seat 10. The core of this embodiment may be formed in the winding manner as described in the previous embodiment.

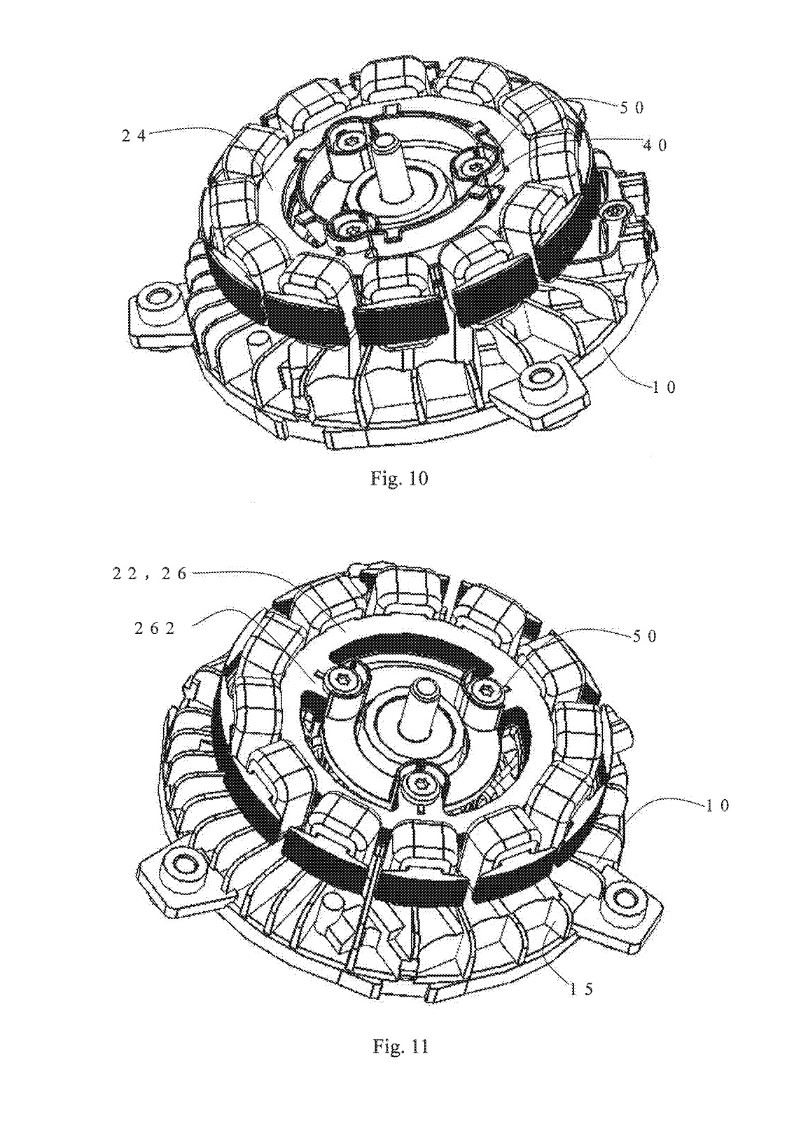

FIG. 10 and FIG. 11 illustrate a motor according to another embodiment of the present invention. In this embodiment, the stator core 22 uses punched sheets, i.e. each lamination of the core 22 is formed by punching, and the laminations are stacked together. The yoke 26 of each lamination of the magnetic core 22 includes a plurality of connecting arms 262 extending inwardly, and each connecting arm 262 forms a through hole. The insulating winding frame 24 includes upper and lower layers that cover top and bottom surfaces of the stacked core 22, respectively, to insulate the core 22 from the windings 25. The insulating winding frame 24 includes a connecting part 40 for assembly and an insulating part 42. The insulating part 42 and the core 22 are matched in profile. Preferably, the insulating part 42 is ring-shaped, and the connecting part 40 includes a plurality of connecting lugs extending inward from the insulating part 42. Each connecting lug 40 has a through hole. The through hole of the connecting part 40 is aligned with the through hole of one corresponding connecting arm 262 of the core 22 and a fixing hole of the support seat 10. The fixing member 50 passes through the respectively through holes and is then fastened in the corresponding fixing hole of the support seat 10, so as to fix the magnetic core 22 and winding frame 24 to the support seat 10. The support seat 10 may be formed from a thermally conductive material such as aluminum. As such the support seat 10 can also provide the heat dissipating function. The surface of the support seat 10 may be provided with a cooling fins to increase the heat dissipating surface area.

In the stator structure 20 of the present invention, the stator core 22 is formed by bending or winding the strip material, which enhances the material utilization rate and reduces the cogging torque, thus improving the operational stability of the motor. In addition, by forming the integrated winding frame 24 with the over-molding process, the winding frame 24 integrally forms the hollow cylinder 46 within the core 22 to connect with the support seal 10. In comparison with the conventional stator core which has the central connecting portion connected with the support seat 10, the core 22 of the present invention saves material and reduces the weight of the stator structure 20 and the motor by forming the winding frame 24 from plastic and connecting the hollow cylinder 46 and the insulating part 42 with the ribs 48,

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A motor comprising: a support seat, a stator structure and a rotor,
wherein the rotor is rotatably mounted on the support seat, and
the stator structure comprises: a core, a winding frame covering the core, and windings wound around the winding frame, the core includes a ring-shaped yoke and a plurality of teeth extending outwardly from the yoke, the winding frame comprises an insulating part covering the core and a connecting part within the insulating part to fixedly connect to the support seat.

2. The motor of Claim wherein each tooth includes a winding portion connected with the yoke and a tip formed at a distal end of the winding portion, the windings are wound around the winding portions, a notch is formed in a connection area between the tip and the winding portion, the tip is partially tilted outwardly before the winding is completed and is pressed to bend inwardly to contact the winding portion after the winding is completed.

3. The motor of claim 1, wherein the core is formed by bending material strips, the yoke of the core has through holes, and fastening members are inserted into the through holes to fix the material strips together.

4. The motor of Claim I, wherein the core is formed by bending material strips, and tips of the core are welded to fixed the strips together.

5. The motor of claim 1, wherein the support seat is formed from a thermally conductive material.

6. The motor of claim 1, wherein cooling fins are provided on a side of the support seat facing the stator structure.

7. The motor of claim 1, wherein one side of the support seat remote from the stator structure forms a receiving cavity, and a circuit board is received in the receiving cavity.

8. The motor of claim 1, wherein the connecting part comprises a ring-shaped base plate extending integrally and radially inwardly from the insulating part, a hollow cylinder extending integrally and axially from an inner edge of the base plate, and a plurality of ribs connected between an outer wall surface of the hollow cylinder and an inner wall surface of the insulating part.

9. The motor of claim 8, wherein the base plate of the winding frame has through holes, the support seat is provided with fixing posts corresponding to the through holes, and fixing members pass through the through holes and are fastened in the fixing posts.

10. The motor of claim 9, wherein the winding frame is an over-molded integrated structure, the fixing members are integrally fixed at the through holes of the winding frame during the course of forming the winding frame, and distal ends of the fixing members pass through the support seat to connect the stator structure with the support seat.

11. The motor of claim 8, wherein the support seat is provided with a positioning post, a step is formed at a top end of the positioning post, the base plate has a positioning hole corresponding to the positioning post, the top end of the positioning post is inserted into the positioning hole, and the stator structure is disposed on the step of the positioning post.

12. The motor of claim 8, wherein one of an inner wall surface of the hollow cylinder of the winding frame and an outer wall surface of the sleeve of the support seat forms a protrusion, and the other forms a recess for engaging with the protrusion to circumferentially position the stator structure.

13. The motor of claim 1, wherein the insulating part is ring-shaped, the connecting part comprises a plurality of connecting lugs extending inwardly from the ring-shaped insulating part, each connecting lug forms a through hole, the support seat forms a plurality of fixing holes corresponding to the through holes of the winding frame, and fixing members pass through the through holes and are fastened in the fixing holes, respectively, to fix the stator to the support seat.

14. The motor of claim 1, wherein the core further includes connecting arms extending inwardly from the ring-shaped yoke, the connecting part of the winding frame includes connecting lugs extending inwardly from the insulating part, the connecting lugs and the connecting arms correspond respectively and form coaxial through holes, the support seat forms a plurality of fixing holes, and fixing members pass through the through holes and are fastened in the fixing holes of the support seat, respectively.

15. The motor of claim 14, wherein one side of the support seat remote from the stator structure forms a receiving cavity, and a circuit board is received in the receiving cavity.
